(19) United States
(12) Patent Application Publication
(10) Pub. No.: US 2016/0043765 A1
(43) Pub. Date: Feb. 11, 2016

(54) PROTECTIVE FILM COMPOSITE

(71) Applicant: BUFFALO INC., Nagoya-shi (JP)

(72) Inventor: Tsuyoshi OZEKI, Nagoya-shi (JP)

(73) Assignee: BUFFALO INC., Nagoya-shi (JP)

(21) Appl. No.: 14/822,532

(22) Filed: Aug. 10, 2015

(30) Foreign Application Priority Data
Aug. 11, 2014 (JP) 2014-163949

(51) Int. Cl. H04B 1/3888

(52) U.S. Cl. CPC H04B 1/3888

(57) ABSTRACT

A protective film composite that includes: a protective film having a first surface and a second surface; a first adhesive material provided on the second surface of the protective film; a release film having a first surface that is removably attached to the second surface of the protective film, and a second surface; and a tab film provided on the second surface of the release film, the tab film extending from one end of the release film to another end of the release film, one end of the tab film being folded back to extend to the first surface of the release film and fixed to the release film, and another end of the tab film extending out of the another end of the release film.

### CROSS REFERENCE TO RELATED APPLICATIONS

This application claims priority to Japanese Patent Application No. 2014-163949 filed on Aug. 11, 2014, the entire contents of which are incorporated by reference herein.

### TECHNICAL FIELD

The present disclosure relates to a protective film composite including a protective film to be stuck on an electronic apparatus, and to a protective film sticking method.

### RELATED ARTS

In electronic apparatuses represented by smartphones and tablet terminals, display surfaces on which images are displayed are protected with a material which is transparent and has certain degrees of strength and hardness, such as glass. In addition, for the purposes of protecting the display surfaces from formation of scratches, restraining the reflection on the display surfaces in a predetermined ratio, and so on, films called protective films which are to be stuck on the display surfaces are provided (see, for example, “Lustrous? Antireflection? The basics of films—Smartphone School,” [searched on Aug. 11, 2014], the Internet <URL: http://buffalo.jp/products/pickup/supply/smapho_school/ar ticle3.html>). Furthermore, a protective film may be stuck also to other surface of an electronic apparatus than the display surface, for instance, a surface which is located on the opposite side from the display surface and which is touched when the electronic apparatus is held by the user. Herein, the protective films to be stuck on display surfaces of the electronic apparatuses and those to be stuck on other surfaces than the display surfaces of the electronic apparatuses will be collectively referred to as “protective film.”

Electronic apparatuses and their display surfaces have predetermined shapes on the basis of the model and the type of electronic apparatus. In addition, some of the electronic apparatuses are provided in the same surface as the display surface with recesses, projections, or openings or the like for an operating button, microphone, speaker and the like, and the positions where the operating button and the like are arranged may vary depending on the model and the type of electronic apparatus. Therefore, the aforementioned protective films are often formed in predetermined shapes according to the models and types of electronic apparatuses. In addition, it is a common practice that a protective film for an electronic apparatus is not stuck on the electronic apparatus at the time of sale of the electronic apparatus but is provided separately from the electronic apparatus. Therefore, the user of the electronic apparatus performs an operation of positioning the protective film according to the shapes of the electronic apparatus and its display surface and then sticking the protective film in situ, when using the electronic apparatus or re-sticking the protective film. The operations from positioning to sticking of these protective films have been conducted individually and manually by the user of each electronic apparatus, since the shapes of the electronic apparatuses and the corresponding protective films differ individually.

A protective film is often provided, on its surface to be adhered to an electronic apparatus, with an adhesive layer for adhering the protective film to the electronic apparatus. In order to protect the adhesive layer until the protective film is stuck on the relevant electronic apparatus, a release film may be initially stuck on the surface provided with the adhesive layer of the protective film. Therefore, it has been a common practice for a user of the electronic apparatus to peel the release film to expose the adhesive layer, prior to sticking the protective film on the electronic apparatus.

When the adhesive layer is exposed, dust floating in the air may be deposited on the adhesive layer. In addition, dust may also be deposited on that surface of the electronic apparatus to which the protective film is to be stuck. Thus, there has been the possibility that dust may be trapped between the protective film and the electronic apparatus when the protective film is stuck on the electronic apparatus. Therefore, it has been necessary for the user to preliminarily remove dust and the like deposited on that surface of the electronic apparatus on which the protective film is to be stuck, then peel the release film, immediately position the protective film, and stick the protective film on the electronic apparatus. Such a process has demanded the user to perform an intricate and swift operation.

In order to render this operation a little easier to carry out, there has been proposed a technology in which a release film is divided near its center, part of the release film is extended outward and bent at an angle of 90 degrees, a protective film with the release film provided thereon is positioned on an electronic apparatus, and the release film in this condition is pulled to peel the release film while turning it up (see, for example, Japanese Patent Laid-Open No. 2014-102481 (hereinafter referred to as Patent Document 1)).

Herein, the term “film” and the term “sheet” are used in the same meaning.

In the related art disclosed in the aforementioned Patent Document 1, however, the direction in which the release film is pulled and the direction in which the release film is peeled are orthogonal to each other. At the time of peeling the release film, therefore, the peeled portion of the release film is largely turned up. As a result, a comparatively large gap is generated between the turned-up portion of the release film and the surface of the electronic apparatus, and there is still a possibility that dust is deposited on at least one of the adhesive layer of the protective film and the surface of the electronic apparatus, in the gap.

### SUMMARY OF THE DISCLOSURE

Accordingly, it is an object of the present disclosure to provide a protective film composite including a protective film and a release film, and a protective film sticking method, by which the possibility of intermediate presence of dust between protective film and electronic apparatus at the time of sticking the protective film on the electronic apparatus can be lowered.

One aspect of the present disclosure provides a protective film composite that includes: a protective film having a first surface and a second surface; a first adhesive material provided on the second surface of the protective film; a release film having a first surface that is removably attached to the second surface of the protective film, and a second surface; and a tab film provided on the second surface of the release film, the tab film extending from one end of the release film to another end of the release film, one end of the tab film being folded back to extend to the first surface of the release film and fixed to the release film, and another end of the tab film extending out of the another end of the release film. By this configuration, at least one of the aforementioned problems is solved.

### BRIEF DESCRIPTION OF THE DRAWINGS

FIG. 1 is a plan view showing a protective film composite according to one aspect of one embodiment of the present disclosure;

FIG. 2 is a sectional view taken along line A-A′ of FIG. 1;

FIG. 3 is an exploded perspective view showing the protective film composite according to the one aspect of the one embodiment;

FIG. 4 is a plan view showing an example of a protective film sticking method using the protective film composite according to the one aspect of the one embodiment;

FIG. 5A is a plan view showing an example of the protective film sticking method using the protective film composite according to the one aspect of the one embodiment;

FIG. 5B is a plan view showing an example of the protective film sticking method using the protective film composite according to the one aspect of the one embodiment;

FIG. 6A is a plan view showing an example of the protective film sticking method using the protective film composite according to the one aspect of the one embodiment;

FIG. 6B is a plan view showing an example of the protective film sticking method using the protective film composite according to the one aspect of the one embodiment;

FIG. 7A is a plan view showing an example of the protective film sticking method using the protective film composite according to the one aspect of the one embodiment;

FIG. 7B is a plan view showing an example of the protective film sticking method using the protective film composite according to the one aspect of the one embodiment;

FIG. 8A is a sectional view showing an example of the protective film sticking method using the protective film composite according to the one aspect of the one embodiment;

FIG. 8B is a sectional view showing an example of the protective film sticking method using the protective film composite according to the one aspect of the one embodiment;

FIG. 8C is a sectional view showing an example of the protective film sticking method using the protective film composite according to the one aspect of the one embodiment;

FIG. 9A is a sectional view showing an example of the protective film sticking method using the protective film composite according to the one aspect of the one embodiment;

FIG. 9B is a sectional view showing an example of the protective film sticking method using the protective film composite according to the one aspect of the one embodiment;

FIG. 10A is a plan view showing a protective film composite according to a second aspect of one embodiment of the present disclosure;

FIG. 10B is a sectional view taken along line B-B′ of FIG. 10A, showing the protective film composite according to the second aspect of the one embodiment; and

FIG. 11 is a plan view showing a protective film composite according to a third aspect of one embodiment of the present disclosure.

### PREFERRED EMBODIMENTS

Embodiments of a protective film composite and a protective film sticking method of the present disclosure will now be described below, referring to the drawings. Note that the thicknesses of a protective film and the like depicted in the drawings are exaggerated for convenience of explanation, and the reduction scale does not reflect actual dimensions. In addition, a film or the like represented as monolayer in the drawings may actually be a laminate or stack of a plurality of films or the like. In other words, the representation in the drawings is a functional one.

### First Aspect

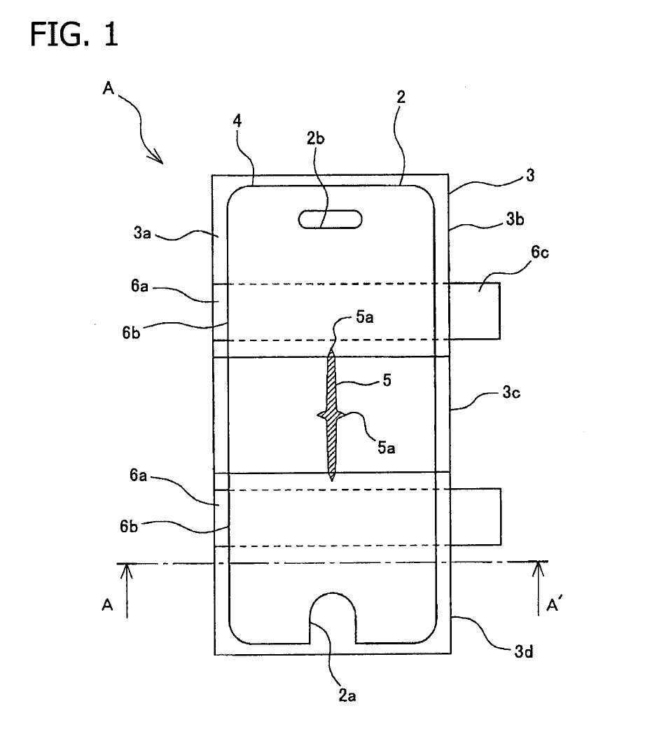

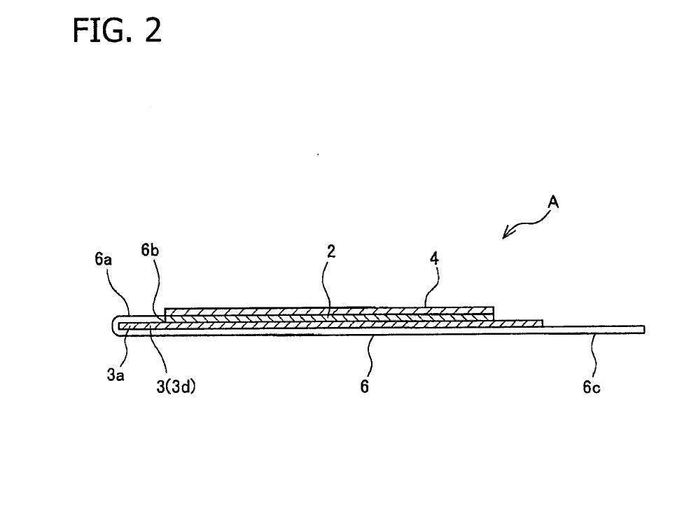

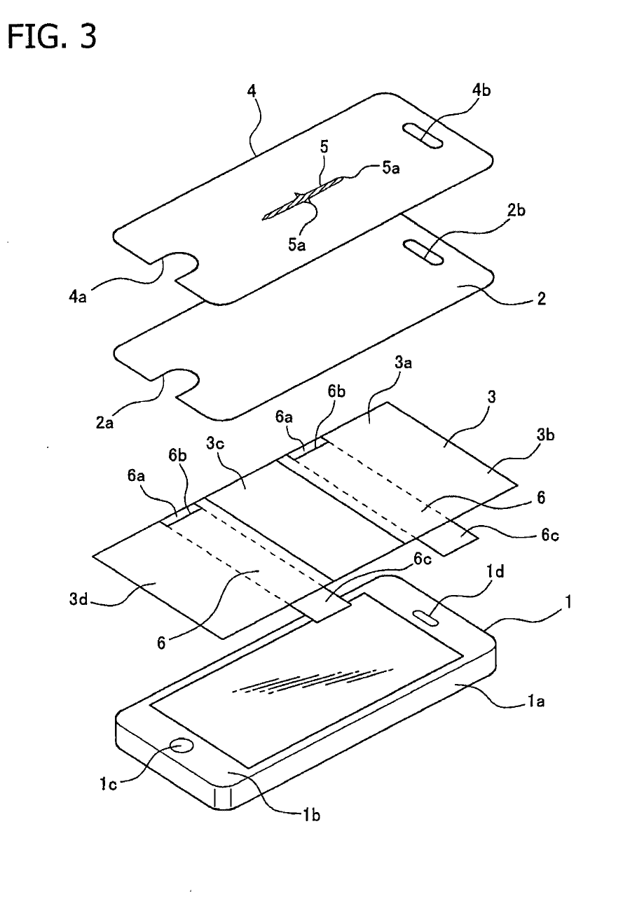

FIG. 1 is a plan view showing a protective film composite according to a first aspect of one embodiment of the present disclosure, FIG. 2 is a sectional view taken along line A-A′ of FIG. 1, and FIG. 3 is an exploded perspective view of the protective film composite. In these figures, numeral 1 denotes an electronic apparatus on which a protective film is to be stuck. The electronic apparatus 1 is represented by a smart phone or a tablet terminal, wherein a main body 1a being substantially rectangular plate-like in external shape is provided at a surface (an upper surface in FIG. 3) thereof with a display section (omitted in the drawing in FIG. 3) where a display screen is to be displayed. The display section has a substantially rectangular display surface 1b exposed from the electronic apparatus 1. The display surface 1b is configured by use of a transparent material composed of a glass, a rigid plastic or the like. In addition, the electronic apparatus 1 includes a touch panel (omitted in the drawing in FIG. 3) for detection of a position of touch on the display surface 1b when a user touches the display surface 1b with a finger or the like.

On the display surface 1b of the electronic apparatus 1, a protective film 2 for protecting the display surface 1b is to be stuck. The protective film 2, in this embodiment, is formed in a rectangular external shape which is slightly smaller than the external shape on the display surface 1b side of the electronic apparatus 1. As shown in detail in FIGS. 2 and 3, the protective film 2 is provided, on its side to be adhered to the display surface 1b (the lower side in FIGS. 2 and 3, this side corresponds to the second surface of the protective film 2), with a first adhesive layer (omitted in the drawing) for adhering the protective film 2 to the display surface 1b, and a release film 3 for protecting the first adhesive layer is provided on the first adhesive layer. Note that in the following description of the embodiment, the side on which the display surface 1b is provided will be described as the upper side of the electronic apparatus 1, and, as for the upper and lower sides of the protective film 2 and the like (the upper side of the protective film 2 corresponds to the first surface of the protective film 2), that side of a member under consideration which is nearer to the display surface 1b will be systematically described as the lower side of the member.

As shown in detail in FIG. 1, the release film 3 is formed in a rectangular external shape greater than the external shape of the protective film 2. In a condition where the release film 3 is stuck on the protective film 2 through the first adhesive layer therebetween, a peripheral portion 3a of the release film 3 is extended outside of the protective film 2. The release film 3 is divided into three divisional release films 3b, 3c, and 3d, as depicted in detail in FIGS. 1 and 3. More in detail, the release film 3 in this embodiment is divided into three sections arrayed along the longitudinal direction of the protective film 2, to form the divisional release films 3b to 3d. Of these divisional release films 3b to 3d, the divisional release film 3c located centrally with respect to the longitudinal direction of the protective film 2 is formed to be shorter, in the length along the longitudinal direction of the protective film 2, than the other divisional release films 3b and 3d.

The release film 3 is provided with tab films 6, having a rectangular external shape, on its surface (the second surface of the release film 3) on the opposite side from its surface (the first surface of the release film 3) to be adhered to the protective film 2 through the first adhesive layer. In this embodiment, two such tab films 6 are provided in respective correspondence with the divisional release films 3b and 3d exclusive of the divisional release film 3c located centrally with respect to the longitudinal direction of the protective film 2. The tab films 6 extend from one longitudinal edge (left edge) to the other longitudinal edge (right edge) of the release film 3 in FIG. 1, that is, along the entire dimension in the width direction of the release film 3.

An end portion 6a on one side of the tab film 6 that is located on the left edge side of the release film 3 in FIG. 1 is folded back at a margin on the left edge side of the release film 3, to extend by a predetermined length onto a surface on the protective film 2 side of a peripheral portion 3a of the release film 3, and is fixed to the release film 3 (see FIG. 2). In this embodiment, the one-side end portion 6a of the tab film 6 extends into the vicinity of the margin on the longitudinal left edge side of the protective film 2 in FIG. 1. Besides, a fixation end 6b of the one-side end portion 6a of the tab film 6 to be fixed to the release film 3 is formed in a substantially rectilinear shape, and the fixation end 6b is so fixed as to be substantially parallel to a longitudinal left edge of the release film 3.

Similarly, an end portion 6c on the other side of the tab film 6 that is located on the right edge side of the release film 3 in FIG. 1 extends outwards by a predetermined length from a margin on the right edge side of the release film 3, to form an extension portion 6c.

The opposite side (the upper side in FIGS. 2 and 3) of the protective film 2 from the side of sticking onto the display surface 1b is the side (surface) of the protective film 2 to be touched by a user. On this side (surface) of the protective film 2 to be touched by the user, there is provided a cover film 4 for protecting the side (surface) to be touched by the user. The cover film 4 is provided with a second adhesive layer (omitted in the drawings) for fixing the cover film 4 to the protective film 2.

The cover film 4 is provided, on the opposite side (the upper side in FIGS. 2 and 3) from the side of fixation to the protective film 2, with a positioning mark 5 to be used for positioning at the time of sticking the protective film 2 on the display surface 1b of the electronic apparatus 1. As depicted in detail in FIGS. 1 and 3, the positioning mark 5 is formed in the shape of a so-called cross in which line segments having predetermined line widths cross each other at their centers, and end portions of the line segments are formed as pointed triangular projecting portions 5a (see FIG. 1).

In this embodiment, as depicted in detail in FIG. 1, two projecting portions 5a of the four projecting portions 5a formed in the positioning mark 5 are represented in positions corresponding to one of the divisional release films 3b to 3d, more specifically, to the divisional release film 3c located centrally with respect to the longitudinal direction of the protective film 2 in FIG. 1. As will be described later, the positioning mark 5 is used for positioning of the protective film 2 in an operation of sticking the protective film 2 on the display surface 1b.

It is sufficient for the positioning mark 5 to be provided, or represented, on the surface of the cover film 4 on the opposite side from the side of fixation to the protective film 2, and the positioning mark 5 may be represented in any manner. For instance, the positioning mark 5 may be printed on the cover film 4. Alternatively, a film of a translucent material may be cut into the shape of the positioning mark 5 and stuck on the cover film 4.

In this embodiment, the protective film 2 and the cover film 4 are formed to be equal in size to or slightly smaller than the external edges of the display surface 1b of the electronic apparatus 1. Alternatively, where the surface (the upper surface in FIG. 3) of the electronic apparatus 1 on the display surface 1b side is formed as a flat surface integral with the display surface 1b, the protective film 2 and the cover film 4 are formed to be equal in size to or slightly smaller than the external edges of the flat surface. It is to be noted that in this embodiment, the electronic apparatus 1 is provided with an operating button 1c and a speaker 1d, and the protective film 2 and the cover film 4 are formed with cutouts or openings 2a, 2b, 4a, and 4b in positions corresponding to the operating button 1c and the speaker 1d of the electronic apparatus 1.

As the protective film 2, the release film 3, the cover film 4, the tab films 6 and, further, the first and second adhesive layers, there can be suitably applied those known films and adhesive layers which have been used as existing protective films and the like. For example, the protective film 2 may be formed from polyethylene terephthalate (PET) in a thickness of 125 μm. The release film 3 also may be formed from PET in a thickness of 50 μm to 75 μm. The cover film 4 also may be formed from PET in a thickness of 50 μm to 75 μm. Further, the tab films 6 may be formed from polyethylene in a thickness of 100 μm to 150 μm. Preferably, the tab films 6 are formed from a translucent or opaque material, from the viewpoint of easy visual confirmation by the user of the tab films 6 being provided. In addition, the tab films 6 are not restricted in regard of material thereof insofar as the material is not easily stretched and is low in rigidity; for example, the tab films 6 may be formed of paper.

Here, the protective film 2 may be processed appropriately, for the purpose of, for example, preventing formation of fingerprints on the protective film 2, enhancing slidability of a user's finger or fingers on the protective film 2, or enhancing the appearance quality of images displayed on the display surface 1b, in the condition where the protective film 2 is stuck on the display surface 1b.

As will be described later, the release film 3 is peeled from the protective film 2 at the time of sticking the protective film 2 on the display surface 1b of the electronic apparatus 1. In view of this, the release film 3 may be processed for preventing electrification of the protective film 2 from occurring when the release film 3 is peeled from the protective film 2. Similarly, the release film 3 may be processed for enhancing the releasability at the time of peeling the release film 3 from the protective film 2.

In addition, the first adhesive layer is formed in a thickness of 50 μm, and the second adhesive layer is formed in a thickness of about 25 μm to 50 μm. After the protective film 2 is stuck on the display surface 1b, at least part of the protective film 2 is peeled for the purpose of, for example, removing an air bubble or bubbles or dust, and thereafter, the peeled part of the protective film 2 is again stuck on the display surface 1b. Taking this into account, a material ensuring good re-releasability and pressure sensitive adhesive properties may be selected for the first adhesive layer, or the first adhesive layer may be given a predetermined processing for ensuring such good properties.

When the protective film 2, the release film 3, the cover film 4, and the tab films 6 are provided for a user, they are provided in the state of being mutually fixed by the first and second adhesive layers as illustrated in FIGS. 1 and 2. Hereinafter, the protective film 2, the release film 3, the cover film 4, and the tab film 6, together with the first and second adhesive layers, in the mutually fixed state as depicted in FIGS. 1 and 2 are collectively referred to as a protective film composite P.

### Protective Film Sticking Method According to the First Aspect

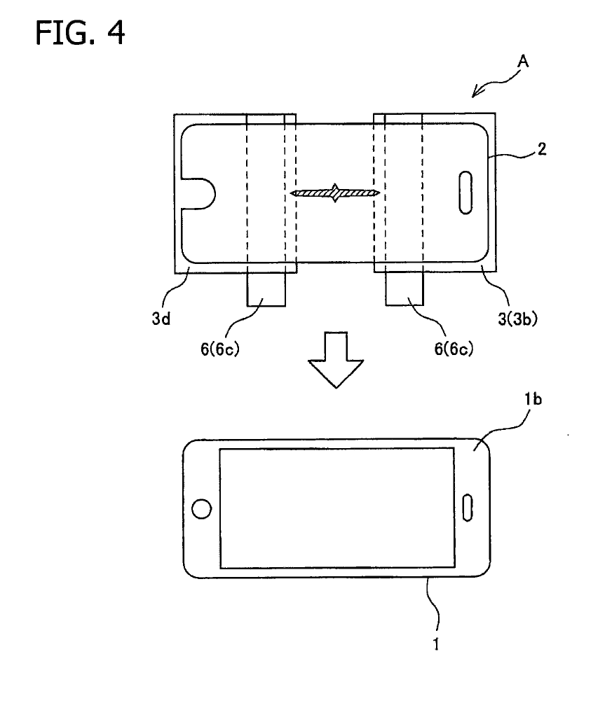

A method of sticking the protective film 2 by use of the protective film composite P according to the first aspect of this embodiment will be described below, referring to FIGS. 4 to 9.

In this aspect, a method of sticking the protective film 2 on the display surface 1b of the electronic apparatus 1 by use of the protective film composite P, as illustrated in FIG. 4, will be described.

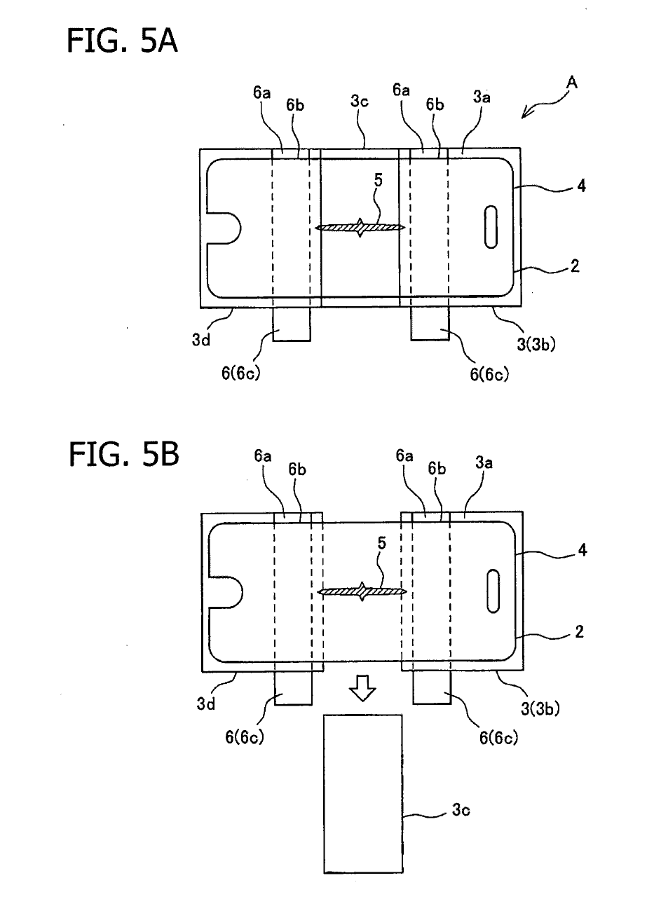

First, as shown in FIG. 5A, the protective film composite P is provided. Next, as shown in FIG. 5B, of the release films 3 constituting the protective film composite P, the divisional release film 3c located centrally in FIG. 5B is peeled (removed) from the protective film composite P. With the divisional release film 3c thus peeled off, the first adhesive layer of the protective film 2 is partly exposed, and, by use of the partly exposed first adhesive layer, the protective film 2 is stuck on the display surface 1b of the electronic apparatus 1 (see FIG. 4).

In this case, it is preferable that a positioning mark, for example, a positioning mark in the shape of a cross in which line segments extending in the longitudinal direction and the width direction of the display surface 1b are crossing each other at their central portions, corresponding to the positioning mark 5 represented on the cover film 4 of the protective film composite P, is displayed on the display surface 1b of the electronic apparatus 1, and positioning of the protective film 2 is carried out by use of the positioning mark 5 and the positioning mark displayed on the display surface 1b. A method for positioning the protective film 2 by use of the positioning mark 5 and the positioning mark displayed on the display surface 1b is disclosed in detail in, for example, (Patent Application No.2014-64145 in Japan), and, therefore, no more description of the method is made here.

As aforementioned, in this aspect of this embodiment, the two projecting portions 5a of the four projecting portions 5a formed in the cross-shaped positioning mark 5 are represented in positions corresponding to the divisional release film 3c located centrally with respect to the longitudinal direction of the protective film 2 in FIG. 4. This divisional release film 3c is a film to be first peeled off at the time of positioning the protective film 2, as depicted in FIG. 5B, and is a film that is not provided with the tab film 6.

The positioning of the protective film 2 and the display surface 1b of the electronic apparatus 1 is preferably carried out by superimposing the projecting portions 5a, which are tip portions of the positioning mark 5, and those of the positioning mark displayed on the display surface 1b on each other. Here, the at least two projecting portions 5a are represented in the positions corresponding to the divisional release film 3c, and, therefore, the user on one hand performs precise positioning by use of these two projecting portions 5a and, on the other hand, sticks the protective film 2 onto the display surface 1b of the electronic apparatus 1 by use of the first adhesive layer partly exposed by the peeling of the divisional release film 3c.

In addition, in the case where the tab films 6 are formed of a translucent or opaque material from the viewpoint of visibility as aforementioned, some of the projecting portions 5a of the positioning mark 5 may possibly be represented in such positions as to be superimposed on the tab film 6, but this produces no problem. Since at least two projecting portions 5a of the positioning mark 5 are represented in positions corresponding to the divisional release film 3c not provided with the tab film 6, both the positioning mark 5 and the positioning mark on the display surface 1b can easily be visually confirmed by the user even when the tab films 6 are formed of a translucent or opaque material. This ensures that the positioning of the protective film 2 and the display surface 1b of the electronic apparatus 1 can be performed precisely.

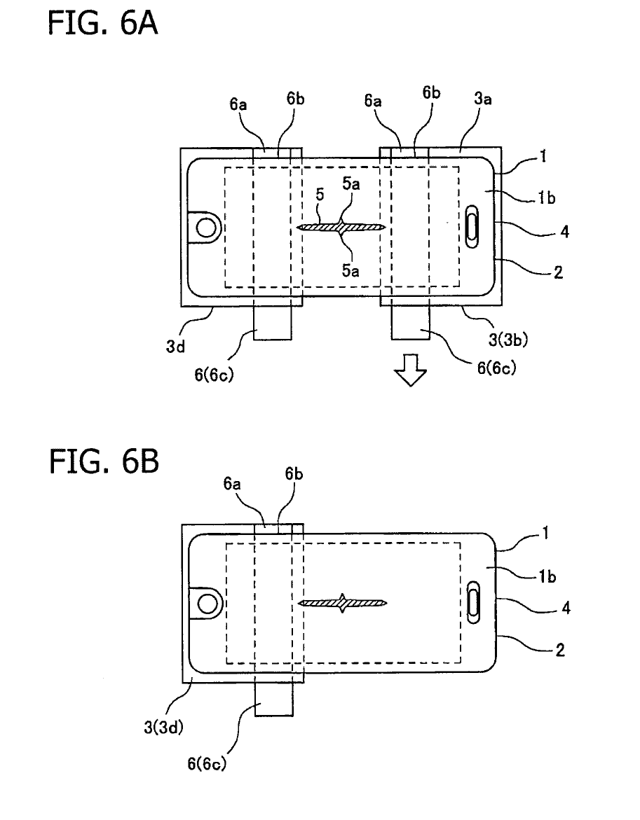

Subsequently, as shown in FIG. 6A, in the condition where the protective film 2 is partly stuck on the display surface 1b of the electronic apparatus 1 by use of the first adhesive layer partly exposed by peeling the divisional release film 3c, the extension portion 6c of the tab film 6 on one side of the two tab films 6 is pulled in a direction away from the protective film 2 (in the downward direction in FIG. 6A). By this operation, as shown in FIG. 6B, the tab film 6 and the divisional release film 3b to which the tab film 6 is fixed are integrally peeled. Then, by use of the first adhesive layer partly exposed by the peeling of the divisional release film 3b, the protective film 2 is stuck on the display surface 1b of the electronic apparatus 1.

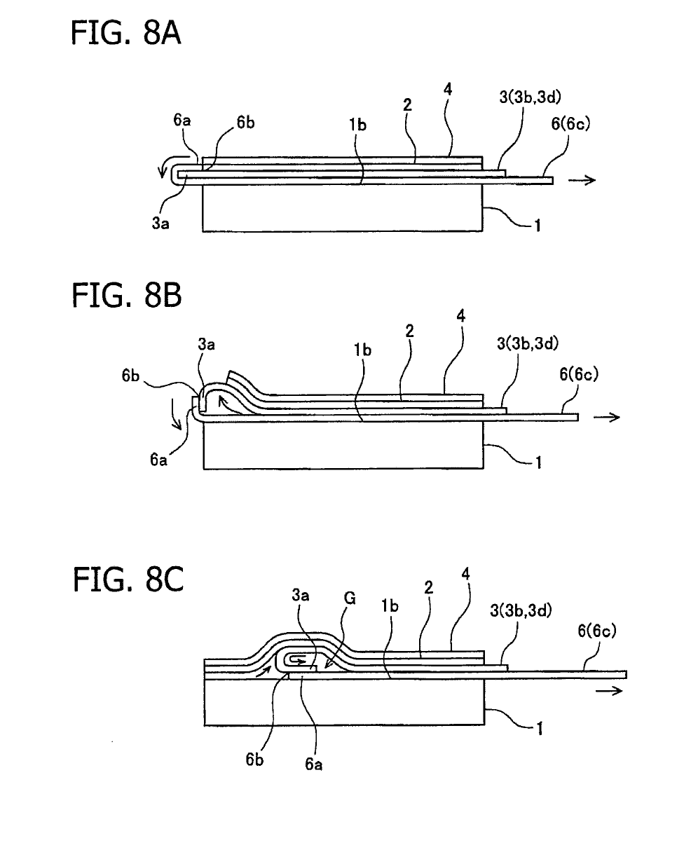

The process of integrally peeling the tab film 6 and the divisional release films 3b and 3d by pulling the tab film 6 will be described in detail, referring to FIGS. 8A and 8B.

First, as shown in FIG. 8A, the extension portion 6c of the tab film 6 is pulled in the direction away from the protective film 2 (in the rightward direction in FIG. 8A), whereon the tab film 6 starts moving as a whole in the direction in which it is pulled, while sliding on the electronic apparatus 1, since there is no adhesive layer or the like between the tab film 6 and (the display surface 1b of) the electronic apparatus 1. As the tab film 6 thus moves, a force in the upper direction in the figure is exerted on the fixation end 6b of the tab film 6 and on the peripheral portion 3a of the divisional release films 3b and 3d to which the fixation end 6b is fixed, with a margin (the left margin in FIG. 8A) of the divisional release films 3b and 3d (which corresponds to a folding-back position of the tab film 6) as a fulcrum. This results in that the peripheral portion 3a is pulled up toward the upper side, as shown in FIG. 8B. With the peripheral portion 3a of the divisional release films 3b and 3d thus pulled up toward the upper side, end portions (left end portions in FIG. 8B) of the protective film 2 and the cover film 4 are bent upward in the manner of following up to the pulling-up of the peripheral portion 3a.

When the tab film 6 is pulled further rightward in FIGS. 8B and 8C under this condition, as shown in FIG. 8C, the end portion 6a of the tab film 6 and the peripheral portion 3a of the divisional release films 3b and 3d are pulled rightward, and, concurrently, a portion near the peripheral portion 3a of the divisional release films 3b and 3d is bent, to form a predetermined gap G between the protective film 2 as well as the cover film 4 and the display surface 1b of the electronic apparatus 1. Since the divisional release films 3b and 3d are formed from a flexible material, however, the gap G does not become large in size.

Then, with the tab film 6 continuedly pulled rightward in the figure, the gap G is sequentially moved rightward in the figure, and, after the passage of the gap G, the divisional release films 3b and 3d are peeled, to result in that the first adhesive layer is exposed. Thereafter, due to the own weights of the protective film 2 and the cover film 4, or by the user's pressing down the protective film 2 and the cover film 4 from above, the protective film 2 is stuck on the display surface 1b of the electronic apparatus 1 through the first adhesive layer therebetween. Through such a process as just mentioned, the divisional release films 3b and 3d are completely peeled from the protective film 2, and the protective film 2 is stuck on the display surface 1b of the electronic apparatus 1 (see FIG. 6B).

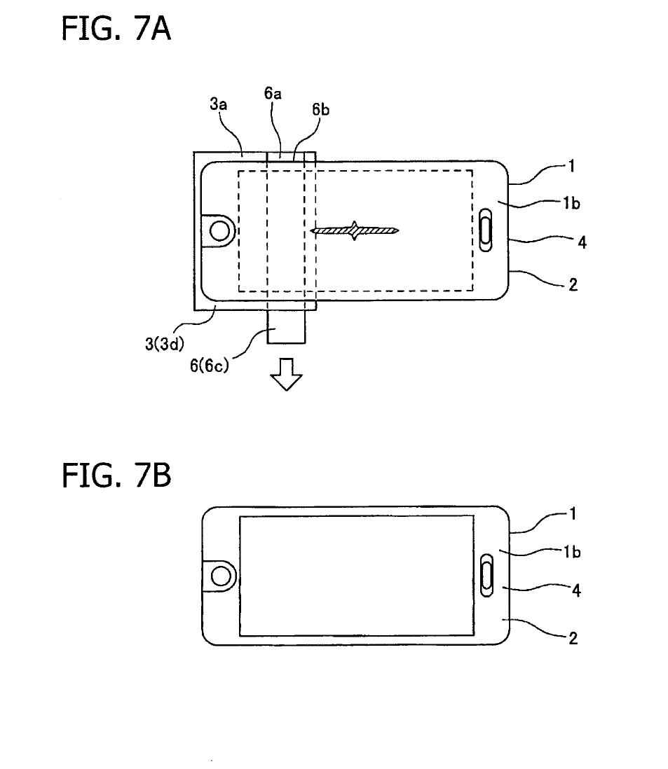

Next, as shown in FIG. 7A, the extension portion 6c of the other, or remaining, tab film 6 of the two tab films 6 is pulled in a direction away from the protective film 2 (in the downward direction in FIG. 7A). By this operation, the tab film 6 and the divisional release film 3b to which the tab film 6 is fixed are integrally peeled off, and by use of the first adhesive layer partly exposed by the peeling of the divisional release film 3b, the protective film 2 is stuck on the display surface 1b of the electronic apparatus 1, as shown in FIG. 7B. As a result, the protective film 2 with the cover film 4 provided thereon is stuck on the display surface 1b of the electronic apparatus 1.

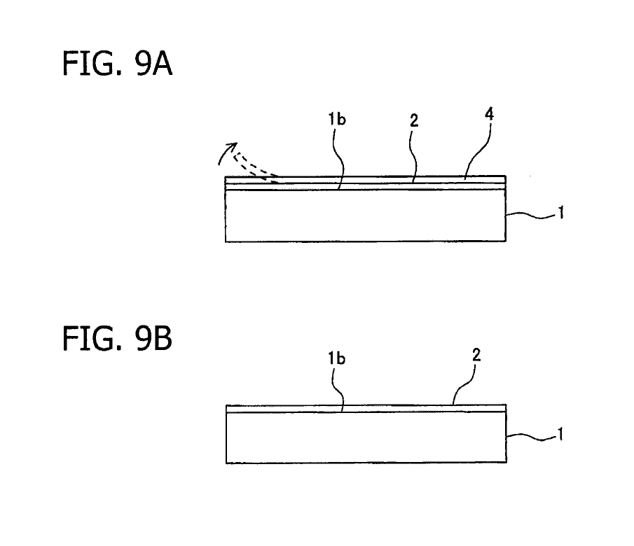

Thereafter, as shown in FIG. 9A, an end portion of the cover film 4 is turned up and the cover film 4 is peeled from the protective film 2. This results in that only the protective film 2 is stuck on the display surface 1b of the electronic apparatus 1, as shown in FIG. 9B.

As has been described above, by use of the protective film composite P according to this aspect of this embodiment, the protective film 2 can be stuck on the display surface 1b of the electronic apparatus 1. Here, in this aspect of this embodiment, the direction in which the tab film 6 is pulled (the downward direction, for example, in FIG. 6A) and the direction in which the divisional release films 3b and 3d are peeled (the downward direction, for example, in FIG. 6A) are substantially coincident with each other, so that that portion of the divisional release films 3b and 3d which are turned up (the portion corresponding to the gap G in FIG. 8C) is smaller as compared with that in the related art. As a result, the possibility of the intermediate presence of dust between protective film and electronic apparatus at the time of sticking the protective film 2 on the electronic apparatus 1 is lowered.

In addition, in the related art, a release film is turned up largely, which is accompanied by large bending (large lifting-up) of a protective film. Where the protective film is formed of a material with appropriate flexibility, for example, an organic material, the protective film may be bent following up to the turning-up of the release film. Where the protective film is formed of a material having little flexibility and being susceptible to rupture in response to a bending stress, such as glass, the protective film may be ruptured upon exertion thereon of a bending stress as a result of the turning-up of the release film. In the related art, accordingly, there have been certain limitations as to the applicable material for the protective film.

On the other hand, in the protective film composite P according to this aspect of this embodiment, that portion of the divisional release films 3b and 3d which are turned up is small, so that the protective film 2 may be formed of a material having little flexibility, such as glass.

### Second Aspect

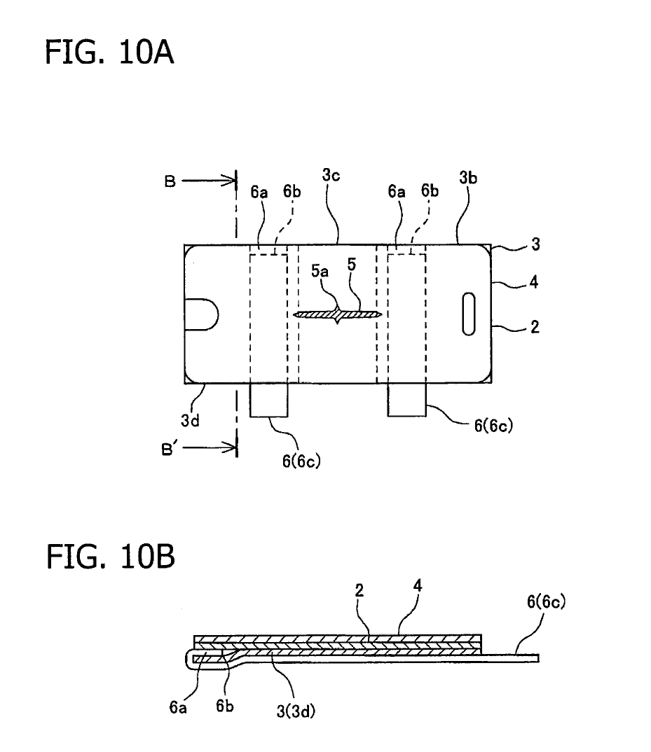

FIGS. 10A and 10B illustrate a protective film composite P according to a second aspect of one embodiment of the present disclosure, wherein FIG. 10A is a plan view showing the protective film composite P, and FIG. 10B is a sectional view taken along line B-B′ of FIG. 10A.

The protective film composite P according to the second aspect of this embodiment differs from the protective film composite P according to the first aspect of this embodiment in that a protective film 2 and a release film 3 are formed in substantially the same rectangular external shape, the other points of configuration being substantially the same as those of the protective film composite P according to the first aspect of this embodiment. In the second aspect of this embodiment, the release film 3 does not have a peripheral portion 3a extending to outside of the protective film 2.

In addition, an end portion 6a on one side of a tab film 6 that is located on the left edge side of the release film 3 is folded back at a margin on the upper edge side of the release film 3 to extend toward the inside of the release film 3, and is located between the release film 3 and the protective film 2. Accordingly, a fixation end 6b of the tab film 6 is also located between the release film 3 and the protective film 2, and is provided in a position inside of the margin on the upper edge side of the release film 3.

By the protective film composite P according to the second aspect of this embodiment, also, the divisional release films 3b and 3d are peeled together with the tab film 6, like by the protective film composite P according to the first aspect aforementioned. Therefore, in the case of the protective film composite P according to the second aspect of this embodiment, also, the sticking of protective film is performed in the same manner as in the case of the protective film composite P according to the first aspect.

### Third Aspect

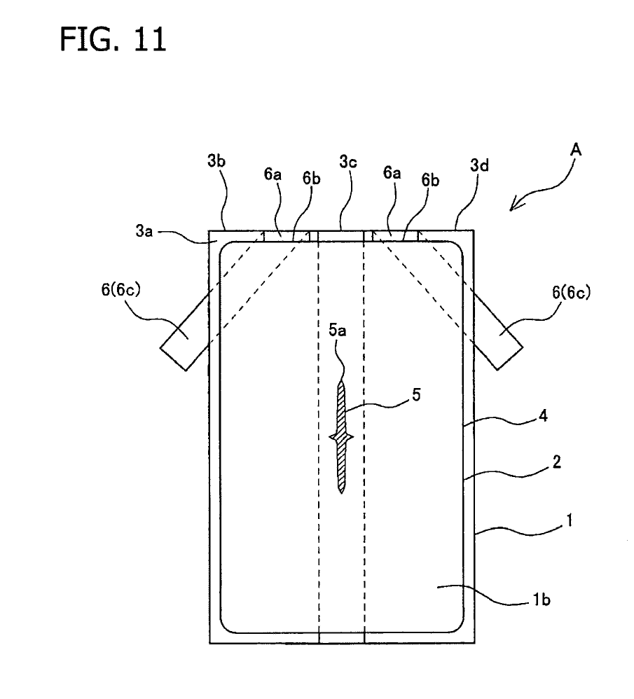

FIG. 11 is a plan view showing a protective film composite P according to a third aspect of one embodiment of the present disclosure. As shown in FIG. 11, the protective film composite P according to the third aspect of this embodiment is to be stuck on a display surface 1b of an electronic apparatus 1 represented by a tablet terminal that is larger in the size of display surface 1b than the electronic apparatus 1 on which the protective film composites P according to the first and second aspects of this embodiment are to be stuck.

In the protective film composite P according to the third aspect of this embodiment, the release film 3 is trisected to form divisional release films 3b to 3d arrayed in the width direction of the protective film 2. Besides, tab films 6 each extend from one widthwise-extending edge (upper edge) to one longitudinal edge (right edge or left edge) of the release film 3 in FIG. 11, in other words, they extend in such directions as to diagonally traverse the release film 3 but not to intersect each other.

Furthermore, all of four projecting portions 5a formed in a positioning mark 5 are represented in positions corresponding to the divisional release film 3c located centrally with respect to the width direction of the protective film 2 in FIG. 11.

The other points of configuration of the protective film composite P according to the third aspect of this embodiment than the just mentioned are substantially the same as those of the protective film composite P according to the first aspect.

By the protective film composite P according to the third aspect of this embodiment, also, the divisional release films 3b and 3d are peeled together with the tab film 6, like by the protective film composite P according to the first aspect aforementioned. Therefore, in the case of the protective film composite P according to the third aspect of this embodiment, also, the sticking of protective film can be performed in the same manner as in the case of the protective film composite P according to the first aspect of this embodiment.

In the protective film composite P according to the third aspect of this embodiment, the direction in which the tab film 6 is pulled (in a right-and-downward diagonal direction or a left-and-downward diagonal direction in FIG. 11) and the direction in which the divisional release films 3b and 3d are peeled (a substantially downward direction in FIG. 11) are not coincident with each other. However, the tab film 6 is folded back at the upper edge of the release film 3 in FIG. 11, and, further, a fixation end 6b of the tab film 6 is so fixed as to be substantially parallel to the widthwise-extending upper edge of the release film 3. Therefore, the direction of a force exerted on the divisional release films 3b and 3d is a little more downward than the direction in which the tab film 6 is pulled. Consequently, in the third aspect of this embodiment, also, that portion of the divisional release films 3b and 3d which are turned up (the portion corresponding to the gap G in FIG. 8C) is smaller than that in the related art.

### Modification

Note that the details of the protective film composite and the protective film sticking method according to the present disclosure are not limited to those in the aforementioned aspects of this embodiment, and can be modified variously. For example, while the above aspects of the embodiments have been described referring to the case where the protective film 2 is to be stuck on the display surface 1b of the electronic apparatus 1, the protective film composite P and the protective film sticking method according to the present disclosure can be suitably applied to the case where the protective film 2 is to be stuck on other surface of an electronic apparatus 1 than a display surface 1b.

In addition, while the peripheral portion 3a of the release film 3 has extended to the entire outside periphery of the protective film 2 in the aforementioned first aspect of the embodiment, the peripheral portion 3a may extend to at least part of the outside periphery of the protective film 2.

Further, while the fixation end 6b of the tab film 6 has extended into the vicinity of the margin of the protective film 2 in the protective film composites P according to the first and third aspects described above, the fixation end 6b may be fixed between the margin of the release film 3 (corresponding to the folded-back portion of the tab film 6) and the margin of the protective film 2. Preferably, the fixation end 6b of the tab film 6 is fixed in the center between the margin of the release film 3 (corresponding to the folded-back portion of the tab film 6) and the margin of the protective film 2, or in a position nearer to the margin of the protective film 2 than the center.

Furthermore, while the release film 3 has been described to be divided into three divisional release films 3b to 3d in the aforementioned examples, the number of pieces into which the release film 3 is divided is not particularly limited but may be appropriately determined taking into account the easiness or simplicity of the production process or the like. In this case, the tab films 6 may be provided in correspondence with respective ones of the divisional release films 3. In addition, even where the release film 3 is not divided, the protective film composite P and the protective film sticking method of the present disclosure can be suitably applied.

Further, even where the positioning mark 5 is not provided, the protective film composite and the protective film sticking method according to this embodiment can be suitably applied.

As aforementioned, this embodiment relates to a protective film composite including: a protective film to be stuck on an electronic apparatus; and a release film provided on a surface of the protective film which surface is to be adhered to the electronic apparatus. On a surface on the opposite side of the release film from the protective film, there are provided tab films each of which extends from one marginal portion to other marginal portion of the release film. An end portion of each tab film located at the one marginal portion of the release film is folded back at the margin of the release film to extend to the surface on the protective film side of the release film, and is fixed to the release film. Further, an end portion of the tab film located at the other marginal portion of the release film is extended by a predetermined length from the other marginal portion of the release film. By this configuration, at least one of the aforementioned problems is solved.

When the end portion of the tab film located at the other marginal portion of the release film is pulled in the direction away from the protective film, a force in a direction away from the electronic apparatus is exerted on the end portion of the tab film located at the other marginal portion of the release film and on the release film to which this end portion is fixed, with the margin of the release film (corresponding to a folded-back position of the tab film) as a fulcrum. Following up to this exertion of the force, an end portion of the protective film 2 is bent. When the end portion of the tab film located at the other marginal portion of the release film is pulled further under this condition, the release film is peeled from the protective film.

Here, a configuration may be adopted wherein the release film is greater than the protective film in external shape, a peripheral portion of the release film extends to at least part of outside of the protective film in the condition where the release film is provided on the protective film, and, of an end portion of the tab film located at one marginal portion of the release film, a portion folded back at the margin of the release film is located at the peripheral portion of the release film.

Alternatively, a configuration may be adopted wherein the release film and the protective film are substantially equal in external shape, and, of an end portion of each tab film located at one marginal portion of the release film, a portion folded back at the margin of the release film is located between the release film and the protective film.

In addition, of the end portion of the tab film located at one marginal portion of the release film, a fixation end to be fixed to the release film is preferably formed in a substantially rectilinear shape. Further, a configuration may be adopted wherein the release film is formed to be substantially rectangular in external shape, and the fixation end of the end portion of the tab film located at one marginal portion of the release film is so fixed as to be substantially parallel to one edge of the release film.

Furthermore, the release film may be provided with a plurality of divisional release films. For example, the release film may be provided with three divisional release films.

Further, the tab films may be provided on the basis of each of a plurality of divisional release films.

Besides, a cover film may be provided on a surface of the protective film which surface is on the opposite side from the surface (of the protective film) to be adhered to an electronic apparatus, and a positioning mark may be represented on the cover film. For example, in the case where the cover film is provided on a surface of the protective film on the opposite side from that surface of the protective film which is to be adhered to the electronic apparatus, a positioning mark having a plurality of projecting portions may be represented on the cover film, and two of these projecting portions may be represented in positions corresponding to one of divisional release films.

In addition, this embodiment relates to a protective film sticking method using a protective film composite. The protective film sticking method includes: disposing and positioning the protective film composite on an electronic apparatus; pulling an end portion of a tab film located at other marginal portion of a release film in a direction away from a protective film, so as to peel the release film from the protective film, starting from the side of an end portion of the tab film located at one marginal portion of the release film; and sticking on the electronic apparatus that portion of the protective film from which the release film has been peeled. By the protective film sticking method as just mentioned, at least one of the aforementioned problems is solved.

Here, a configuration may be adopted wherein the release film is provided with at least two divisional release films, tab films are provided on the basis of each of the plurality of divisional release films, and, at the time of disposing and positioning the protective film composite on an electronic apparatus, at least one divisional release film is peeled from the protective film, and that portion of the protective film from which the divisional release film has been peeled is stuck on the electronic apparatus.

According to this embodiment, that portion of the release film which is turned up becomes small in size. As a result, there is provided a protective film composite and a protective film sticking method such that the possibility of intermediate presence of dust between a protective film and an electronic apparatus at the time of sticking the protective film on the electronic apparatus is lowered.

Another aspect of the present disclosure provides a method of sticking a protective film by use of a protective film composite. The protective film composite includes the protective film to be stuck on an electronic apparatus, a release film provided on a surface of the protective film which surface is to be adhered to the electronic apparatus, and a tab film provided on a surface of the release film which surface is on an opposite side from the protective film, the tab film extending from one marginal portion to an other marginal portion of the release film, the tab film having an end portion which is located at the one marginal portion of the release film and which is folded back at a margin of the release film to extend to a surface of the release film on the protective film side and be fixed to the release film, and the tab film having an end portion which is located at the other marginal portion of the release film and which extends by a predetermined length from the other marginal portion of the release film. The method includes: disposing and positioning the protective film composite on the electronic apparatus; pulling the end portion of the tab film located at the other marginal portion of the release film in a direction away from the protective film so as to peel the release film from the protective film, starting from the side of the end portion of the tab film located at the one marginal portion of the release film; and sticking on the electronic apparatus that portion of the protective film from which the release film has been peeled.

While the present disclosure is described in terms of preferred or exemplary embodiments, it is not limited hereto.

What is claimed is:

1. A protective film composite comprising:
a protective film having
a first surface, and
a second surface;
a first adhesive material provided on the second surface of the protective film;
a release film having
a first surface that is removably attached to the second surface of the protective film via the first adhesive material, and
a second surface; and
a tab film provided on the second surface of the release film, the tab film extending from one end of the release film to another end of the release film, one end of the tab film being folded back to extend to the first surface of the release film and fixed to the release film, and another end of the tab film extending out of the another end of the release film.

2. The protective film composite according to claim 1, wherein
the release film is greater than the protective film in external shape, a peripheral portion of the release film extending to at least part of outside of the protective film in a condition where the release film is provided on the protective film, and
the one end of the tab film is folded back to extend to the first surface of the release film at the peripheral portion of the release film.

3. The protective film composite according to claim 1, wherein
the release film and the protective film are substantially equal in external shape, and
a portion of the one end of the tab film folded back to extend to the first surface of the release film is located between the release film and the protective film.

4. The protective film composite according to claim 1,
wherein the one end of the tab film fixed to the release film is formed in a substantially rectilinear shape.

5. The protective film composite according to claim 1,
wherein the release film is substantially rectangular in external shape, and
the one end of the tab film fixed to the release film is so fixed as to be substantially parallel to one edge of the release film.

6. The protective film composite according to claim 1,
wherein the release film includes a plurality of divisional release films.

7. The protective film composite according to claim 6,
wherein the release film includes at least three divisional release films.

8. The protective film composite according to claim 6,
wherein the tab film includes a plurality of tab films.

9. The protective film composite according to claim 1, further comprising:
a cover film provided on the first surface of the protective film, a positioning mark being provided on the cover film.

10. The protective film composite according to claim 6, further comprising:
a cover film provided on the first surface of the protective film, a positioning mark having a plurality of projecting portions being provided on the cover film, and at least two of the projecting portions being provided in positions corresponding to one of the divisional release films.

11. The protective film composite according to claim 1, wherein the release film is to be removed from the protective film composite to adhere the second surface of the protective film to a surface of an electronic apparatus via the first adhesive.

12. The protective film composite according to claim 11, wherein the release film is to be removed from the protective film composite after the protective film composite is disposed on the surface of the electronic apparatus.

13. The protective film composite according to claim 1, wherein the release film is to be removed from the protective film composite together with the tab film by moving a portion of the tab film extending out of the another end of the release film in a direction from the one end of the tab film to the another end of the tab film.

14. The protective film composite according to claim 1, wherein the release film is to be removed from the protective film composite together with the tab film by moving a portion of the tab film extending out of the another end of the release film in a direction different from a direction from the one end of the tab film to the another end of the tab film.

15. The protective film composite according to claim 6, wherein at least one of the plurality of divisional release films is to be removed from the protective film composite together with the tab film by moving a portion of the tab film extending out of the another end of the release film in a direction from the one end of the tab film to the another end of the tab film.

16. The protective film composite according to claim 9, wherein the cover film is provided on the first surface of the protective film via a second adhesive material.

17. The protective film composite according to claim 9, wherein the cover film is to be removed from the protective film composite.

18. The protective film composite according to claim 1, wherein the release film is made of more flexible material than the protective film.

19. The protective film composite according to claim 1, wherein a thickness of the protective film is greater than a thickness of the release film.

20. The protective film composite according to claim 1, wherein the tab film is made of a translucent material.
